(19) United States
(12) Patent Application Publication
(10) Pub. No.: US 2005/0044077 A1
(43) Pub. Date: Feb. 24, 2005

(54) Method and device for providing information, and computer product

(75) Inventor: Chiharu Shibata, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/938,587

(22) Filed: Sep. 13, 2004

Related U.S. Application Data
(63) Continuation of application No. PCT/JP02/02509, filed on Mar. 15, 2002.

(51) Int. Cl. G06F 7/00

(52) U.S. Cl. 707/6

(57) ABSTRACT

An information providing method includes receiving, from a terminal device of a user, position information that identifies a location, and time information that identifies a time by which the user must reach the location, calculating an available time period that is from a current time up to the time identified by the time information, identifying establishments that can be visited within the available time period calculated, from among establishments near the location, and transmitting establishments identified, to the terminal device.

### BACKGROUND OF THE INVENTION

1) Field of the Invention

The present invention relates to a method and device for providing information, and computer product that provide information pertaining to establishments around any location, on a terminal device of a user.

2) Description of the Related Art

Shops and restaurants are often found near crowd-pulling establishments such as cinema houses, theaters, and stadiums, the former and the latter enjoying a mutually beneficial relation. The businesses in the shops and restaurants usually benefit from patrons who arrive early for a show or who want to stop by after the show.

Sometimes, if tickets for the current show are not available, patrons have an unexpectedly long waiting time until the next show. This free time can be spent usefully if they are familiar with the surrounding establishments. Otherwise, a lot of time is likely to be wasted in looking for a particular shop or restaurant.

Moreover, even though there are people milling around, the shops have to find a way to draw the attention of the people.

### SUMMARY OF THE INVENTION

It is an object of the present invention to provide a method and a device for providing information, and a computer product that will enable the user to effectively utilize unexpected free time.

An information providing method according to an aspect of the present invention includes receiving position information from a terminal device of a user, wherein the position information identifies a location; receiving time information from the terminal device, wherein the time information identifies a time by which the user must reach the location; calculating an available time period that is from a current time up to the time identified by the time information; identifying establishment information that is establishments that can be visited within the available time period, from among establishments near the location; and transmitting the establishment information to the terminal device.

An information providing device according to another aspect of the present invention includes a position information receiving unit that receives position information from a terminal device of a user, wherein the position information identifies a location; a time information receiving unit that receives time information from the terminal device, wherein the time information identifies a time by which the user must reach the location; an available time calculating unit that calculates an available time period that is from a current time up to the time identified by the time information; an establishment information identifying unit that identifies establishment information that is establishments that can be visited within the available time period, from among establishments near the location; and an establishment information transmitting unit that transmits the establishment information to the terminal device.

A computer program according to still another aspect of the present invention causes a computer to realize the above method according to the present invention.

A computer-readable recording medium according to still another aspect of the present invention records thereon the above computer program according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a configuration of an information providing system according to an embodiment of the present invention;

FIG. 2 is a block diagram of a server in the information providing system;

FIG. 3 is a block diagram of a client in the information providing system;

FIG. 4 is a functional configuration of the information providing system;

FIG. 5 illustrates a cinema house table;

FIG. 6 illustrates a required time table;

FIG. 7 illustrates an establishment table;

FIG. 8 illustrates a search result table;

FIG. 9 is a flowchart of an information providing process performed by the information providing system;

FIG. 10 is a detailed flowchart of a search condition input process shown in FIG. 9;

FIG. 11 is a sample of an initial screen displayed at the client side;

FIG. 12 is a sample of a show time display screen displayed at the client side;

FIG. 13 is a sample of a show time list display screen displayed at the client side;

FIG. 14 is a detailed flowchart of an establishment type extraction process shown in FIG. 9;

FIG. 15 is a detailed flowchart of an establishment extraction process shown in FIG. 9; and

FIG. 16 is a sample of an establishment information display screen of the client.

### DETAILED DESCRIPTION

Exemplary embodiments of a method and a device for providing information, and a computer product are explained next with reference to the accompanying drawings.

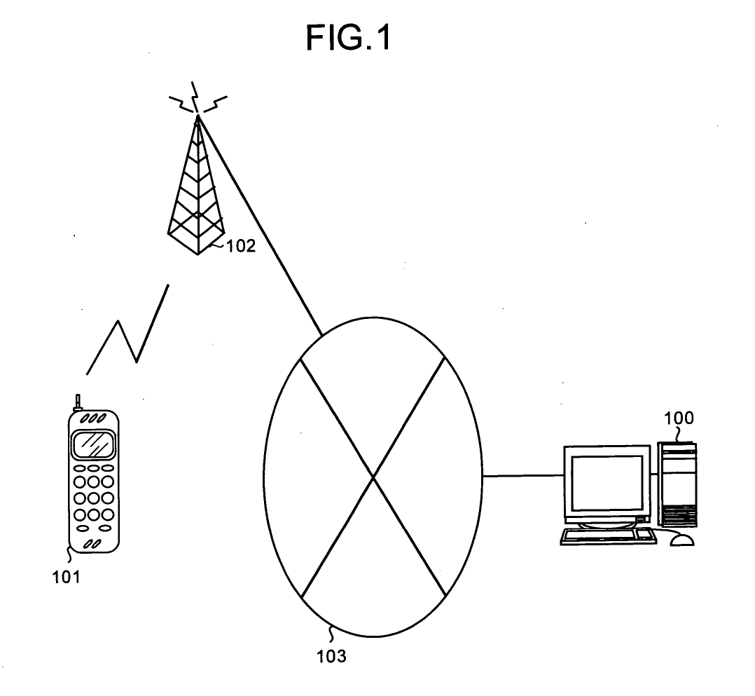

The configuration of an information providing system according to an embodiment of the present invention is explained next with reference to FIG. 1. The reference numeral 100 represents a server of the information providing device according to the present embodiment. The reference numeral 101 represents any client in the form of a portable terminal. The reference numeral 102 represents a wireless base station that transmits and receives wireless radio waves from the client 101. The reference numeral 103 represents the Internet. The server 100 and the client 101 are connected to the Internet 103 via the wireless base station 102.

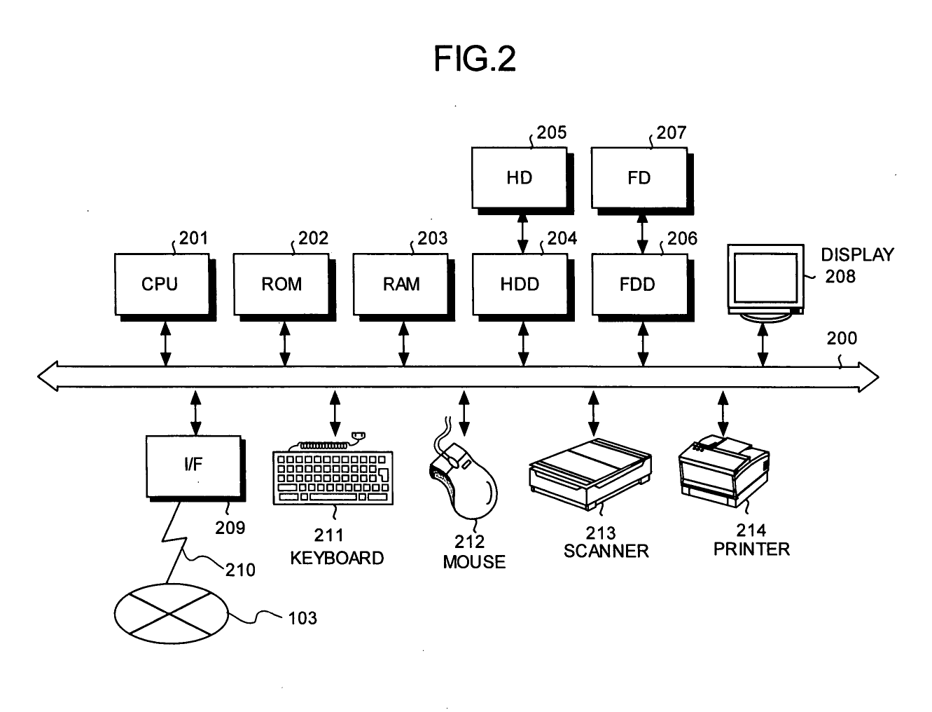

The hardware configuration of the server 100 is explained next. FIG. 2 is a block diagram of the server 100.

The server 100 includes a central processing unit (CPU) 201, a read-only memory (ROM) 202, a random access memory (RAM) 203, a hard disk drive (HDD) 204, a hard disk (HD) 205, a floppy disk drive (FDD) 206, a floppy disk (FD) 207, a display 208, an interface (I/F) 209, a keyboard 211, a mouse 212, a scanner 213, and a printer 214. The FD 207 is a removable recording medium.

The FDD 206, based on the control of the CPU 201, controls the reading/writing of data from/to the FD 207. Based on the control of the FDD 206, the FD 207 stores write data or permits the stored data to be read by a magnetic head of the FDD 206. Other removable recording mediums, such as compact disk—read-only memory (CD-ROM) including compact disk—recordable (CD-R) and compact disk—rewritable (CD-RW), magneto optical disk (MO), digital versatile disk (DVD), memory card, etc. may also be used instead of the FD 207. The display 208 displays cursors, icons, toolboxes, etc. as well as windows containing data such as text, images, information pertaining to functions, etc.

The I/F 209 is connected to the Internet 103 through a communication line 210, and to information processing devices including the client 101. The I/F 209 enables transmission and reception of data between the Internet 103 and the device, and controls the input/output of data between the information processing devices. The I/F 209 may, for instance, be a modem.

The keyboard 211 includes keys by which text, numbers, instructions, etc. can be input into the device. The keyboard 211 may be a touch panel type input pad or a numeric keyboard. The mouse 212 is used for selecting a range for cursor movement, or for moving or resizing a window. If similar functions can be realized, a trackball, joystick, arrow key, jog dial, etc. may also serve the purpose as a pointing device.

The scanner 213 optically scans images, and loads the scanned data as image data to the device. The printer 214 prints the image data or text data and may be a laser printer, ink jet printer, and the like.

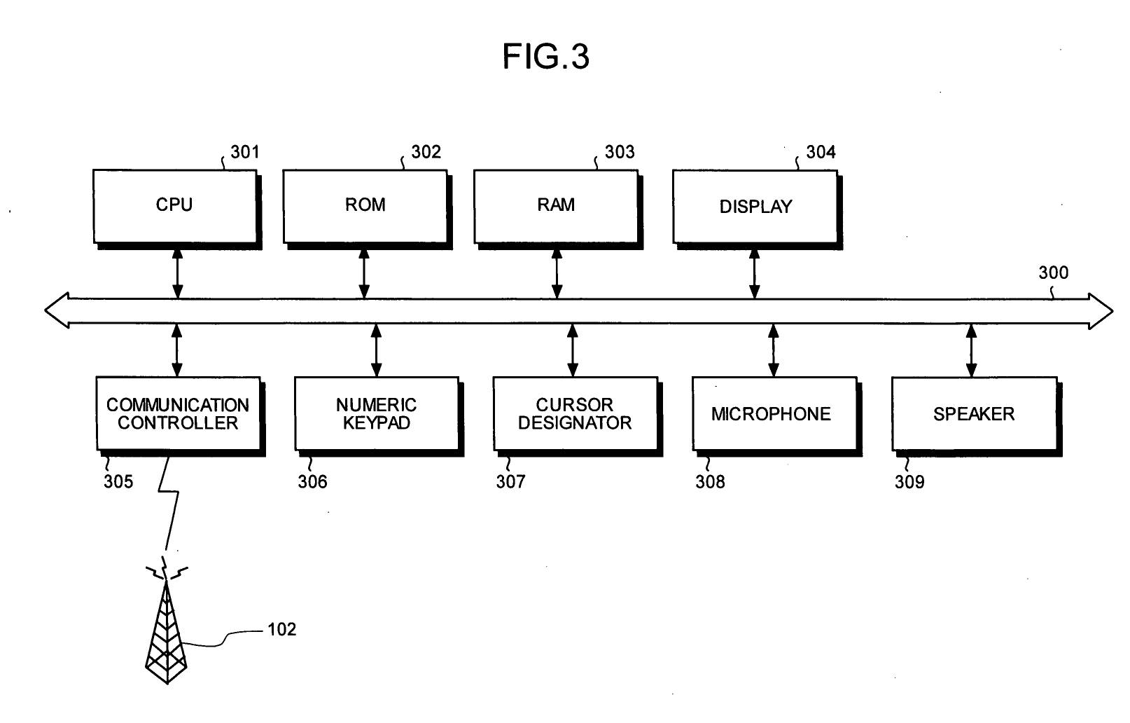

The hardware configuration of the client 101 is explained next with reference to FIG. 3. FIG. 3 is a block diagram of the client 101. The client 101 in the present embodiment is a mobile phone. However, the client 101 may also be a personal digital assistant (PDA) or a notebook personal computer (PC).

The client 101 includes a central processing unit (CPU) 301, a read-only memory (ROM) 302, a random access memory (RAM) 303, a display 304, a communication controller 305, a numeric keypad 306, a cursor designator 307, a microphone 308, and a speaker 309. A bus 300 connects all the parts of the client 101.

The CPU 301 controls the entire client 101. The ROM 302 stores various programs, such as a boot program, etc. The RAM 303 is used as a work area for the CPU 301. The display 304 displays cursors, icons, toolboxes, etc. as well as data such as text data, image data, information pertaining to functions, etc. The display 304 may, for instance, be a thin film transistor (TFT) liquid crystal display.

The communication controller 305 controls the transmission and reception of radio waves between the wireless base station 102 and the device. The communication controller 305 is connected to the wireless base station 102 as well as to the server 100 via the Internet 103. The communication controller 305 enables transmission and reception of data between the Internet 103 and the device, and controls the input/output of data between the Internet 103 and the server 100.

The numeric keypad 306 includes keys by which text, numbers, instructions, etc. can be input into the device. The cursor designator 307 is used for selecting a range for cursor movement. If similar functions can be realized, an arrow key, jog dial, etc. may also serve the purpose as a pointing device. The microphone 308 converts an input sound into an electrical signal. The speaker 309 converts an input electrical signal to a sound. The microphone 308 and the speaker 309 both function as a telephone.

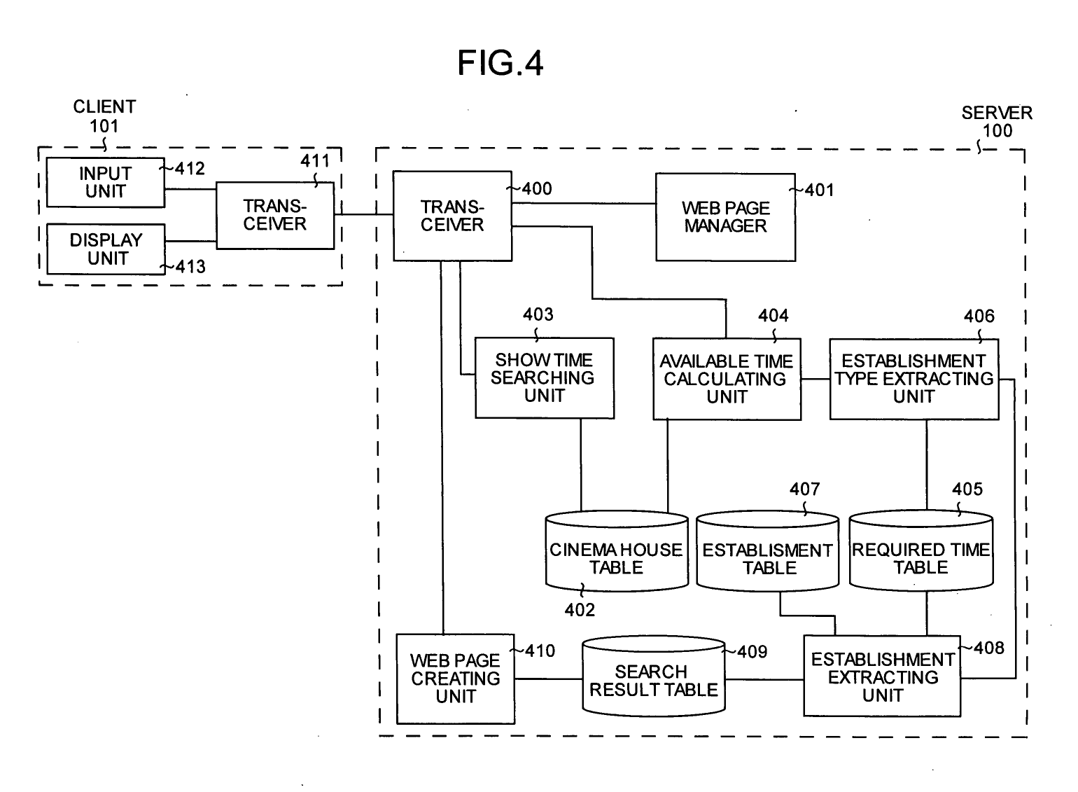

The functional configuration of the information providing system is explained next. FIG. 4 is a functional configuration of the information providing system. The server 100 includes a transceiver 400, a Web page manager 401, a cinema house table 402, a show time searching unit 403, an available time calculating unit 404, a required time table 405, an establishment type extracting unit 406, an establishment table 407, an establishment extracting unit 408, a search result table 409, and a Web page creating unit 410. The client 101 includes a transceiver 411, an input unit 412, and a display unit 413.

The transceiver 400 of the server 100 controls the transmission and reception of data between the server 100 and the outside. The transceiver 400 may, for instance, be realized by a driver for the transceiver 400 loaded on the I/F 209 and the RAM 203 shown in FIG. 2. The contents of the data transmitted and received by the transceiver 400 are described later.

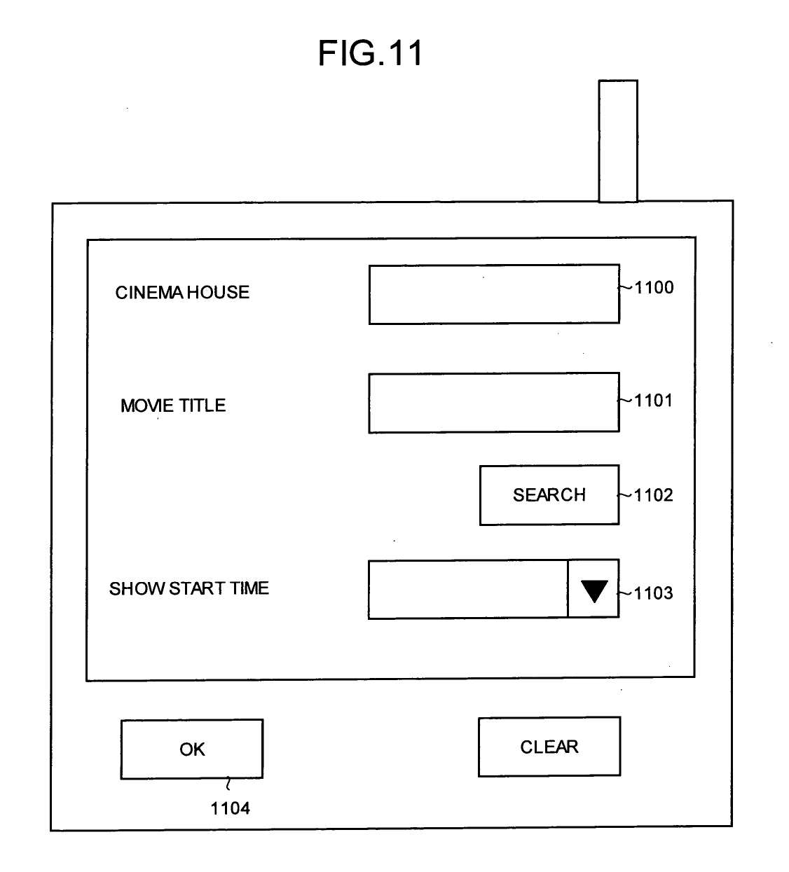

The Web page manager 401 stores files required for creating a Web page. The Web page, shown in FIG. 11, is explained later. Upon receiving a request from the transceiver 400 to send a Web page, the Web page manager 401 retrieves the constituent files of the requested Web page, and transfers them to the transceiver 400. The Web page manager 401 may, for instance, be realized by the HD 205 and by the HDD 204 that controls the HD 205 shown in FIG. 2.

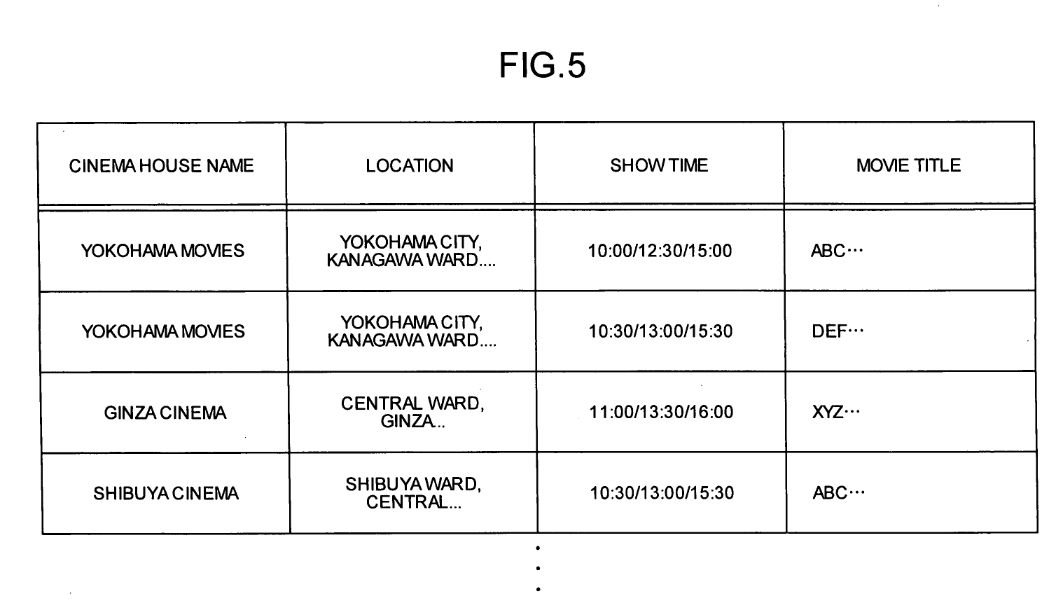

The cinema house table 402 stores, as shown in FIG. 5, ‘cinema house name’, ‘location’, ‘show time’, and ‘movie title’. The information in the cinema house table 402 is built in advance by the operator of the information providing service, and includes data gathered from the cinema houses, trade organizations, publications, etc. The cinema house table 402 may, for instance, be maintained on the HD 205 shown in FIG. 2, and may be loaded from the HD 205 to the RAM 203.

When the user of the client 101 specifies the cinema house and the movie name, the show time searching unit 403 searches the field ‘cinema house name’ of the cinema house table 402 to determine the corresponding record. The show time searching unit 403 then reads the field ‘show time’ of the determined record. In other words, the show time searching unit 403 reads the start time of the specified movie at the specified cinema house (although ‘show start time’ is an accurate term, for the sake of brevity this term is hereafter referred to as ‘show time’). The show time searching unit 403 then sends the retrieved show time to the transceiver 400. The functions of the show time searching unit 403 are realized when the CPU 201 loads to the RAM 203 and executes the program stored on the HD 205, FD 207, etc. shown in FIG. 2.

When the user of the client 101 specifies the cinema house, the movie name, and the show time, the available time calculating unit 404 calculates the available time period, that is, the time from the current time until the show time of the specified movie at the specified cinema house.
(Available time period)=(show time of the specified movie)−(current time)

The functions of the available time calculating unit 404 are realized when the CPU 201 loads to the RAM 203 and executes the program stored on the HD 205, FD 207, etc. shown in FIG. 2.

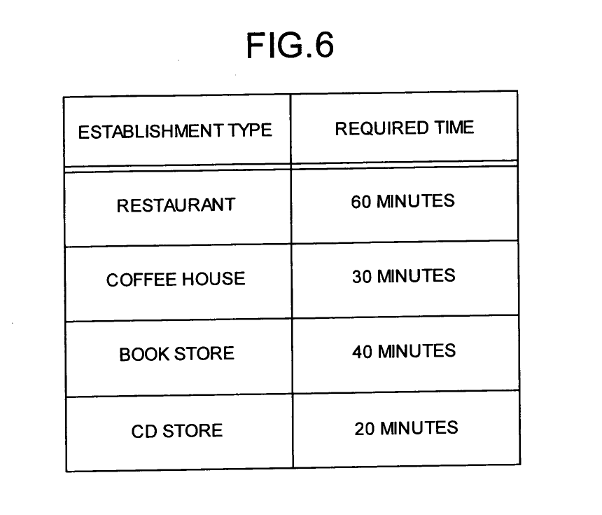

The required time table 405 has two fields, namely ‘establishment type’ and ‘required time’, as shown in FIG. 6. The required time table 405 shown in FIG. 6 is prepared in advance by the operator of the information providing service. The field ‘establishment type’ indicates the various types of establishments and may for instance include restaurant, coffee shop, bookstore, CD store, etc.

The field ‘required time’ indicates an average time period expected to be spent in the establishment. For instance, the required time in a restaurant is estimated to be around 60 minutes, and a coffee shop is estimated to be around 30 minutes, and is set by the operator of the information providing service. The required time table 405 is stored in the HD 205 shown in FIG. 2. Alternatively, the required time table 405 may be loaded to the RAM 203.

The establishment type extracting unit 406 identifies the establishment that can be visited in the available time period calculated by the available time calculating unit 404. In other words, the establishment type extracting unit 406 browses sequentially, the field ‘required time’ of the required time table 405 shown in FIG. 6. If there exists a record in which the required time that is less than the available time period calculated by the available time calculating unit 404, the establishment type extracting unit 406 writes the record to a temporary establishment type table. Thus, the temporary establishment type table is essentially a subset of the required time table 405. The value in the field ‘establishment type’ of each record of the temporary establishment type table indicates the establishment type that can be visited in the available time period.

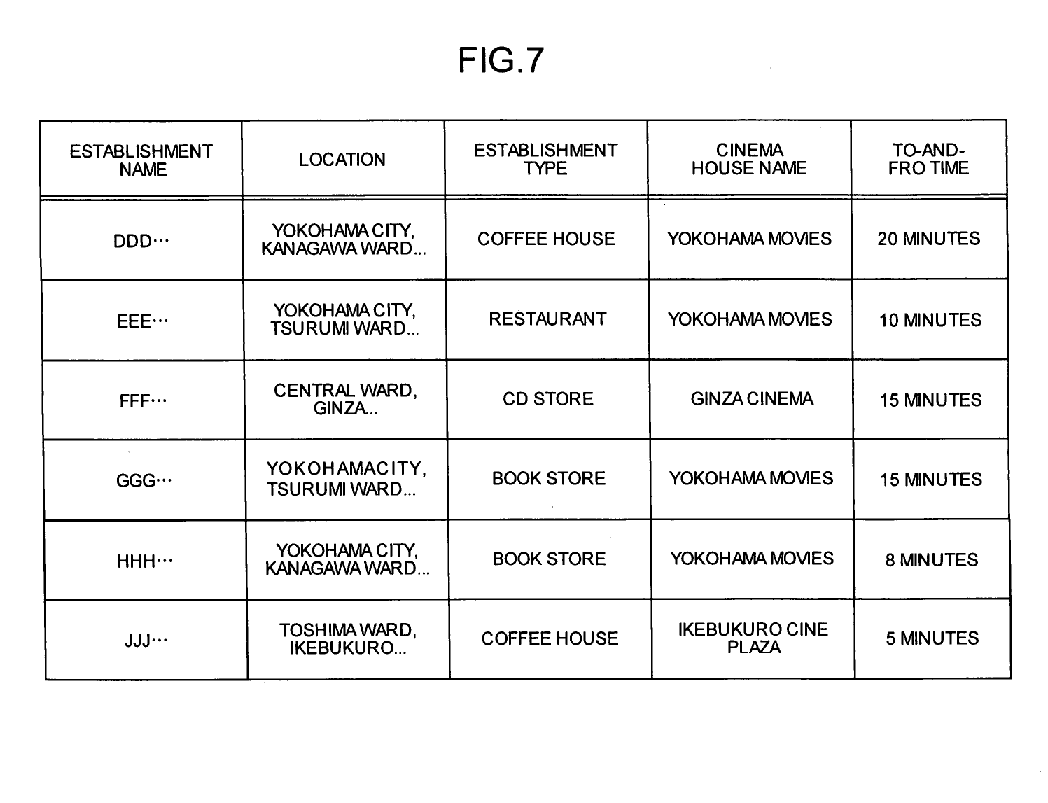

The establishment table 407 includes five fields, namely, ‘establishment name’, ‘location’, ‘establishment type’, ‘cinema house name’, and ‘to-and-fro time’, as shown in FIG. 7. The operator of the information providing service prepares the establishment table 407 shown in FIG. 7 in advance. The operator may prepare the establishment table 407 either by receiving requests for registration from the establishments, or by making a registration form available via the Internet 103 to enter the relevant details in the fields in the establishment table 407.

In FIG. 7, the field ‘establishment name’ indicates the name of the establishment. The field ‘location’ indicates the location of the establishment. The field ‘establishment type’ indicates the type of the establishment, and is the same as the ‘establishment type’ in the required time table 405. The field ‘cinema house name’ indicates the name of the cinema house, and usually includes the names of the cinema houses near the establishment, but need not necessarily exclude cinema houses that are not close to the establishment. The field ‘to-and-fro time’ indicates the time taken to walk from a cinema house in the field ‘cinema house name’ to the establishment and back. The establishment table 407 is stored in the HD 205 shown in FIG. 2. Alternatively, the establishment table 407 may be loaded from the HD 205 to the RAM 203.

The establishment extracting unit 408 identifies, from among the establishments of all types extracted by the establishment type extracting unit 406, those establishments that can be actually visited within the available time period. In other words, the establishment extracting unit 408 browses sequentially, the fields ‘establishment type’, ‘cinema house name’, and ‘to-and-fro time’ in the establishment table 407 shown in FIG. 7. The establishment extracting unit 408 extracts the records that satisfy the following three conditions, namely, (1) the value of the field ‘establishment type’ matches any of the establishment types extracted by the establishment type extracting unit 406, (2) the value of the field ‘cinema house name’ matches the cinema house name specified by the user, and (3) the sum of the required time for the establishment and the time to the establishment and back to the cinema house is within the available time period. The establishment extracting unit 408 writes the extracted records to a temporary establishment table. Thus, the temporary establishment table is essentially a subset of the establishment table 407. The value of the field ‘establishment name’ of each record in the temporary establishment table indicates the establishment that can be visited within the available time period.

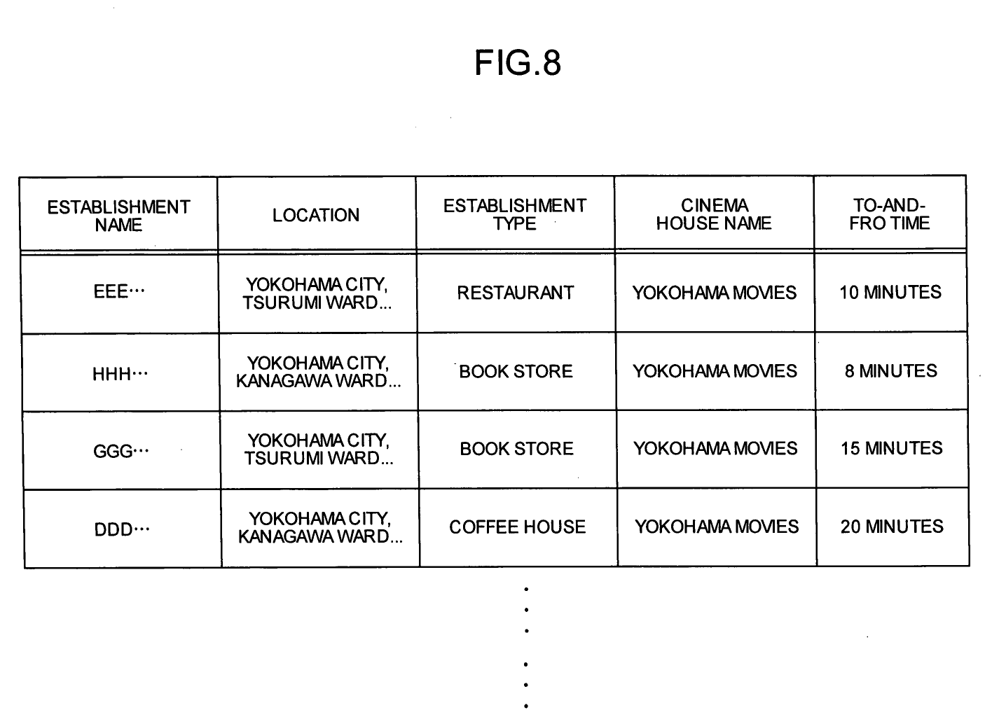

The search result table 409 is a table obtained by assembling the temporary establishment table created by the establishment extracting unit 408. The search result table 409 is also a subset of the establishment table 407, as shown in FIG. 8. The search result table 409 is temporarily created in the RAM 203 upon request from the client 101, and is erased once the Web page creating unit 410 creates a search result page.

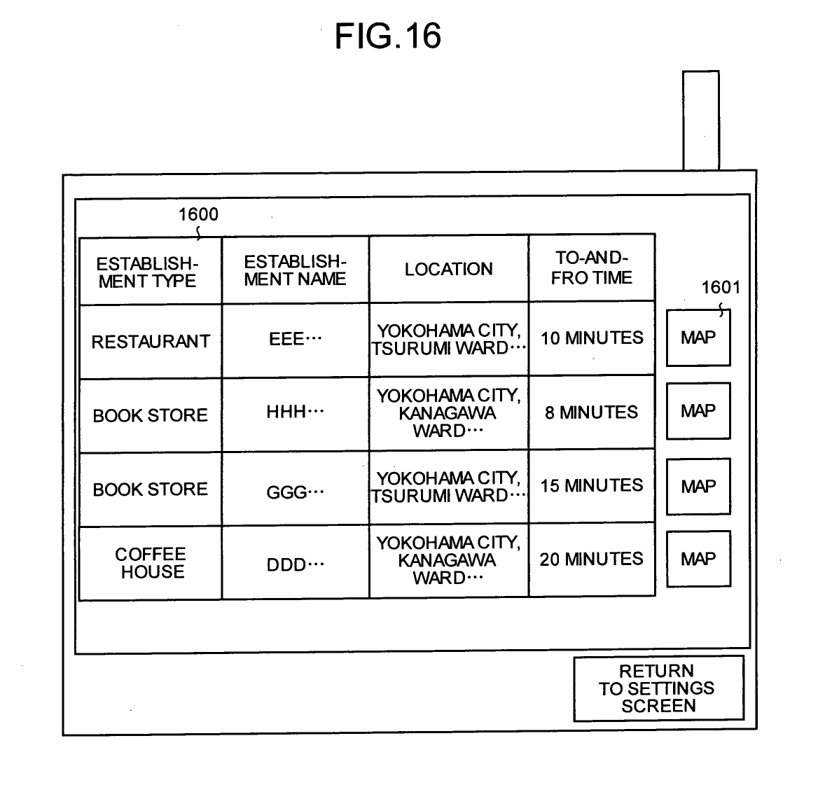

The Web page creating unit 410 refers to the search result table 409, creates a Web page as shown in FIG. 16, and sends the Web page to the transceiver 400. The functions of the Web page creating unit 410 are realized when the CPU 201 loads to the RAM 203 and executes the program stored on the HD 205, FD 207, etc. shown in FIG. 2.

The transceiver 411 of the client 101 controls transmission and reception of data between the client 101 and the outside. The transceiver 411 is realized by the communication controller 305 shown in FIG. 3. The contents of the data transmitted and received by the transceiver 411 are explained later.

The input unit 412 receives various operations from the user, and inputs data such as text string, commands, and the like into the client 101. The functions of the input unit 412 are, for instance, realized by the numeric keypad 306 or the cursor designator 307 shown in FIG. 3. The display unit 413 displays the Web page received from the transceiver 411, or the text string input using the input unit 412. The display unit 413 is, for instance, realized by the display 304 shown in FIG. 3.

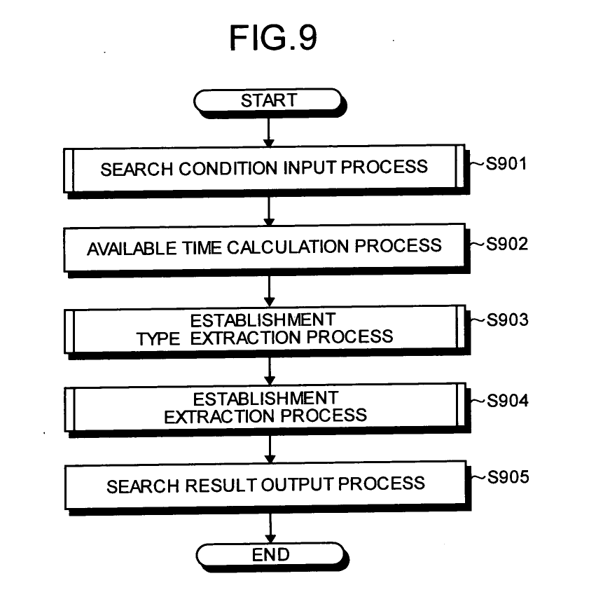

The information providing process of the information providing system according to the present embodiment is explained next. FIG. 9 is a flowchart of the information providing process of the information providing system. The information providing process broadly includes five steps, namely, search condition input process (Step S901), available time calculation process (Step S902), establishment type extraction process (Step S903), establishment extraction process (Step S904), and search result output process (Step S905). The five steps are explained sequentially below.

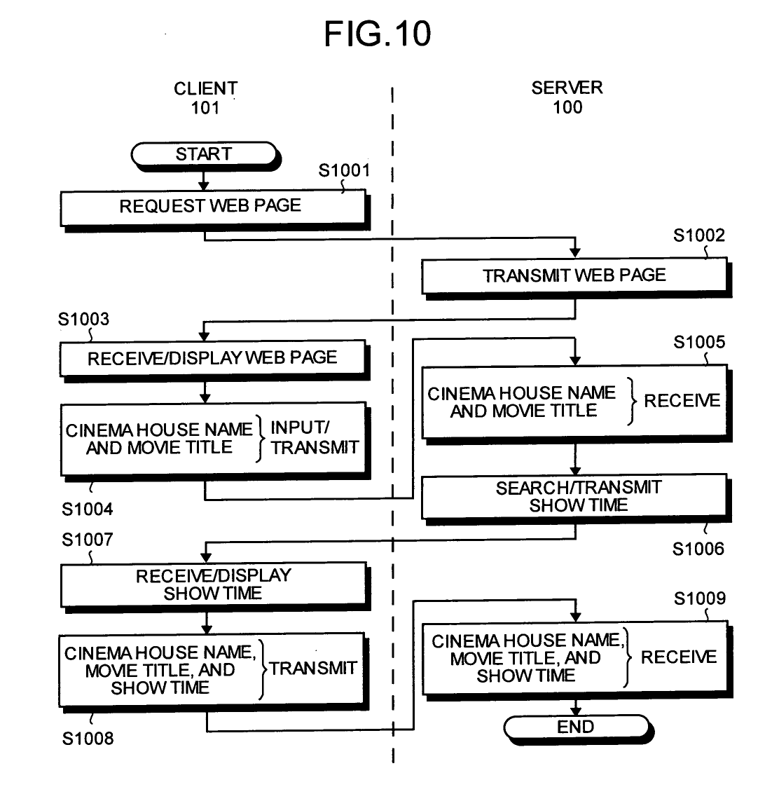

FIG. 10 is a flowchart of the search condition input process of Step S901 of FIG. 9. The user of the client 101 inputs the URL of the Web page of the server 100, that is, the URL of the Web page manager 401 of the server 100. When the user hits any key after entering the URL, the transceiver 411 of the client 101 receives the request for the Web page containing the URL from the input unit 412, and transmits it to the wireless base station 102 (Step S1001). The request for the Web page implies request for the file group that forms the page.

The transceiver 400 of the server 100 receives the request via the wireless base station 102 and the Internet 103. Upon receiving the request for the Web page, the Web page manager 401 of the server 100 sends the constituent files of the Web page identified by the URL to the transceiver 400, and the transceiver 400 transmits those files to the Internet 103 (Step S1002).

The transceiver 411 of the client 101 receives the files via the Internet 103 and the wireless base station 102. The display unit 413 of the client 101 displays the received files as a single Web page (Step S1003). FIG. 11 is a sample of an initial screen displayed at Step S1003 at the client 101.

The user of the client 101 inputs a name of the cinema house (for example, ‘Yokohama movie’) in the cinema house input area 1100, and the title of the movie the user wishes to see (for example, ‘ABC . . . ’) in the movie name input area 1101 on the screen shown in FIG. 11. Subsequently, when the user hits the search button 1102, the transceiver 411 transmits the cinema house name and the movie title to the server 100 (Step S1004).

The transceiver 400 of the server 100 receives the cinema house name and the movie title via the wireless base station 102 and the Internet 103 (Step S1005). The transceiver 400 transfers the cinema house name and the movie title to the show time searching unit 403. The show time searching unit 403 refers to the cinema house table 402, and reads the show start time of the movie of the specified title at the specified cinema house. The show time is then transferred to the transceiver 400, and transmitted to the client 101 via the wireless base station 102 and the Internet 103 (Step S1006).

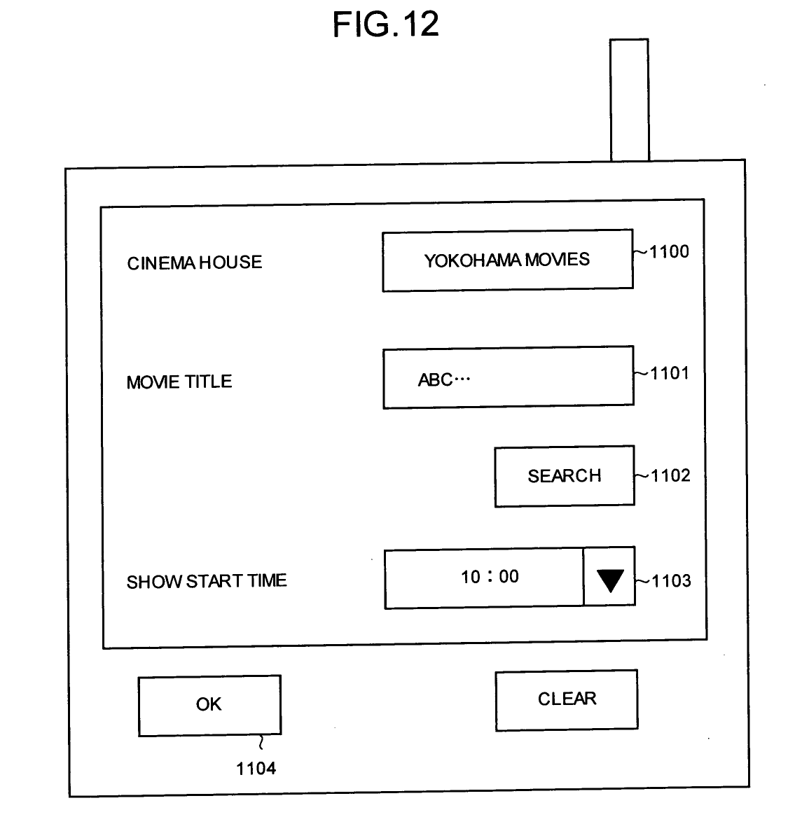

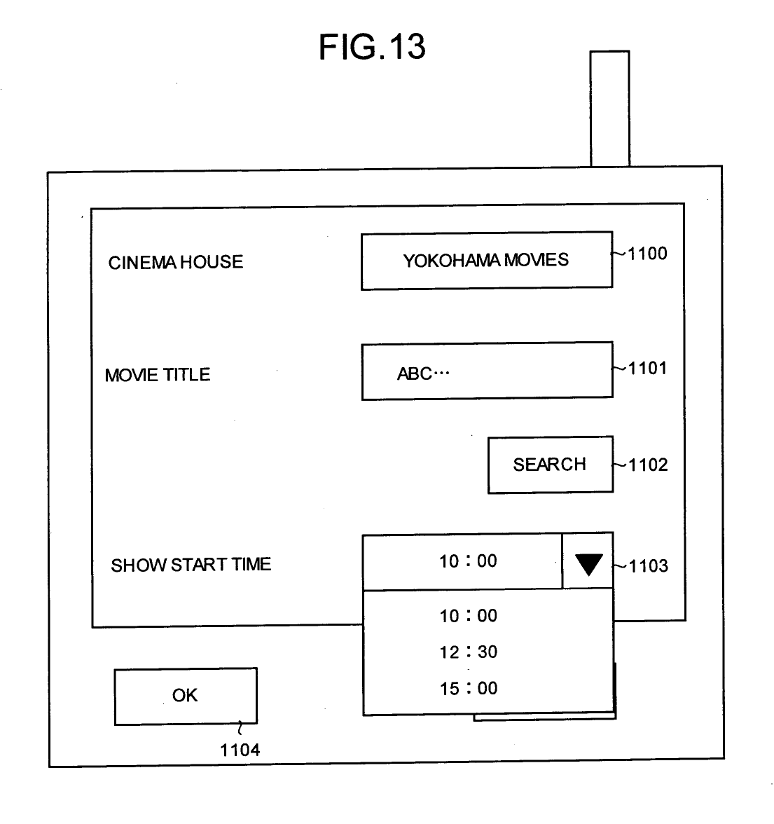

The transceiver 411 of the client 101 receives the show time, and the display unit 413 displays the show time in the show time list 1103 on the screen shown in FIG. 11 (Step S1007). FIG. 12 is a sample of a show time display screen displayed at the client 101 at Step S1007. Upon clicking the down arrow next to the show time list 1103 in FIG. 12, a list of show times for the movie, transmitted from the server 100, is displayed as shown in FIG. 13.

When the user of the client 101 selects any one show time from the show time list 1103, and clicks on the ‘OK’ button 1104, the cinema house name, the movie title, and the preferred show time is transmitted from the transceiver 411 to the server 100 (Step S1008).

At least the cinema house name and the show time must be specified. The movie title is optional. The cinema house name is required because this data identifies a location. The show time is required because this data identifies a time by which the user must reach the location, and this includes reaching the cinema house from another location as well as visiting another location from the cinema house and returning to the cinema house. Alternatively, any format may be used, as long as the location and the time can be identified. For instance, instead of the cinema house name, the current location can be transmitted in the form of latitude and longitude. However, in such case, the position data pertaining to the cinema house in the establishment table should also be in latitudes and longitudes. This is required in the establishment extraction process of Step S904. The server 100 receives the data from the transceiver 400 (Step S1009), and the search condition input process of Step S901 shown in FIG. 9 ends. The process proceeds to the available time calculation process of Step S902 shown in FIG. 9.

The transceiver 400 of the server 100 transfers the received data to the available time calculating unit 404. The available time calculating unit 404 calculates the difference between the current time and received show time, that is the time period available until the show time, and transfers the calculated available time period along with the data to the establishment type extracting unit 406 (Step S902 in FIG. 9).

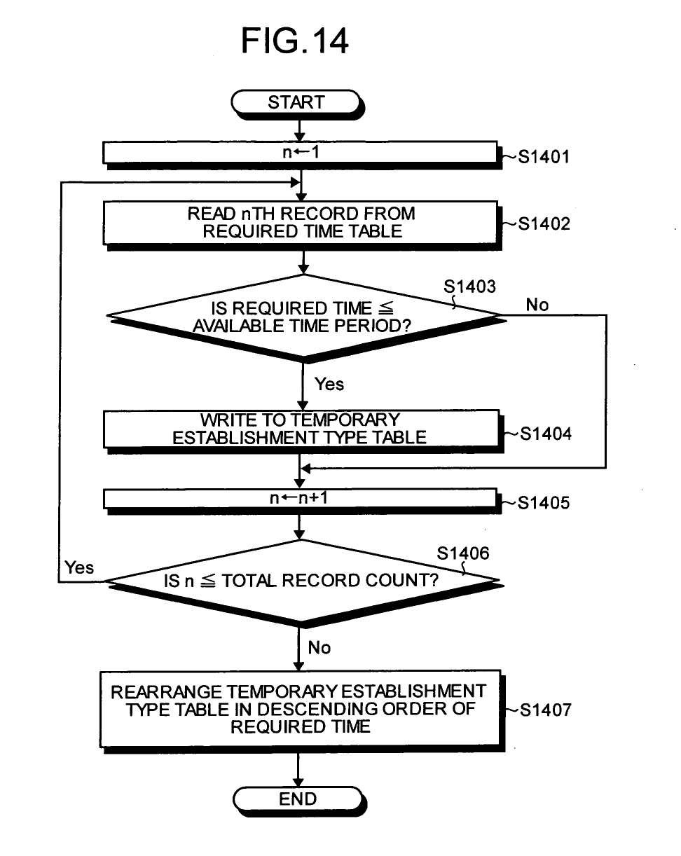

The establishment type extracting unit 406 extracts the establishment type that can be visited within the available time period. FIG. 14 is a flowchart of the establishment type extraction process of Step S903 in the flowchart illustrated in FIG. 9.

The establishment type extracting unit 406 resets a variable n that indicates the record number of the record of interest of the required time table 405 (Step S1401), reads the nth record of the required time table 405 (Step S1402), and checks if the required time set in the field ‘required time’ is within the available time period transferred from the available time calculating unit 404 (step S1403).

If the required time is within the available time period (Yes at Step S1403), the establishment type extracting unit 406 writes the n^{th} record to the temporary establishment type table (Step S1404). If the required time is more than the available time period (No at Step S1403), no record is written to the temporary establishment type table, and the process proceeds to Step S1405.

The establishment type extracting unit 406 then increments the variable n by 1 (Step S1405), and determines if the variable n after incrementing is less than or equal to the total count of records stored in the required time table 405 (Step S1406). If the variable n after incrementing is less than or equal to the total count of the records stored in the required time table 405 (Yes at Step S1406), the establishment type extracting unit 406 repeats the process for the n^{th} record, that is, the next record, in the required time table 405 (that is, the process returns to Step S1402). If the variable n is more than the total count of the records in the required time table 405 (No at Step 1406), the establishment type extracting unit 406 arranges the records in the temporary establishment type table in the descending order of ‘required time’, that is, in such a way that the longest required time is first on the list and the shortest required time is last (Step S1407).

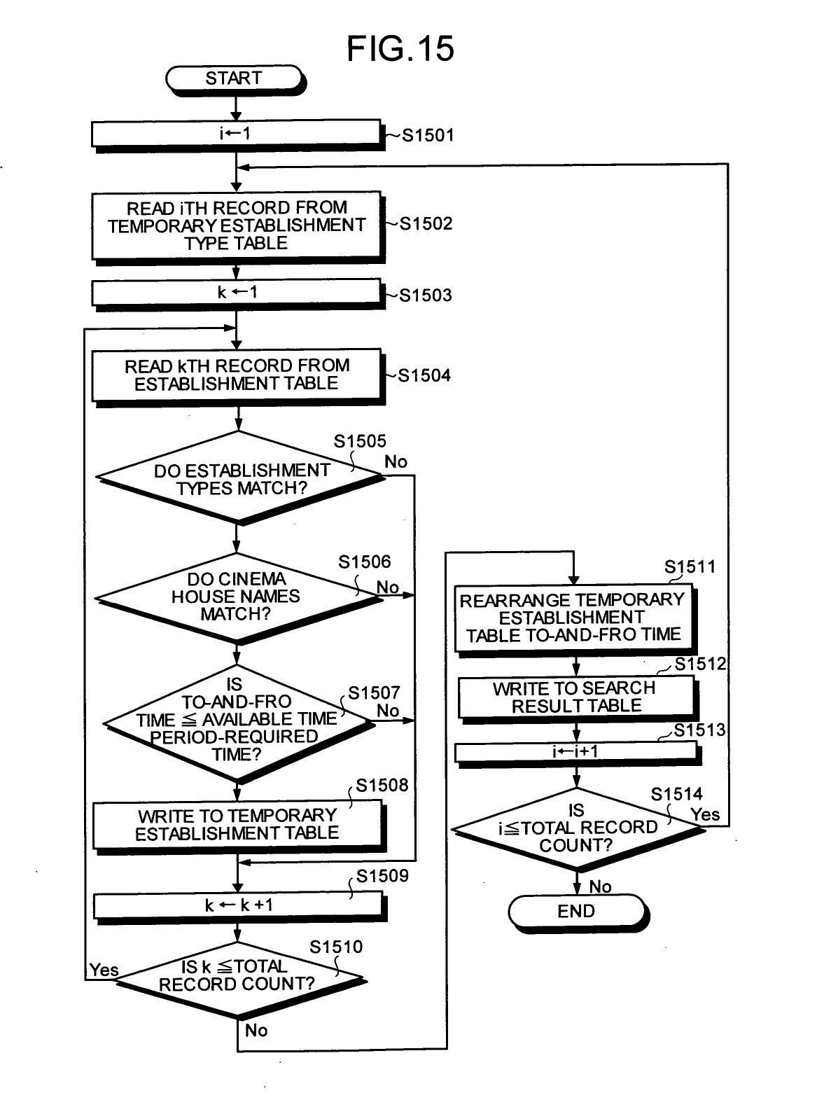

The establishment type extraction process of Step S903 shown in FIG. 9 ends. The process then proceeds to the establishment extraction process of Step S904 shown in FIG. 9. FIG. 15 is a flowchart of the establishment extraction process of Step S904. The establishment extraction process is carried out entirely by the establishment extracting unit 408 of the server 100.

The establishment extracting unit 408 resets a variable i that indicates the record number of the record of interest of the temporary establishment type table created by the establishment type extracting unit 406 (Step S1501), and reads the i-th record of the temporary establishment type table (Step S1502). The establishment extracting unit 408 then resets a variable k that indicates the record number of the record of interest in the establishment table 407 (Step S1503), and reads the k-th record of the establishment table 407 (Step S1504).

The establishment extracting unit 408 then determines if the ‘establishment type’ of the k-th record matches the ‘establishment type’ of the i-th record (Step S1505). If the two values match (Yes at Step 1505), the establishment extracting unit 408 further determines if the ‘cinema house name’ of the k-th record matches the cinema house name received at the end of the search condition input process of Step S901 shown in FIG. 9. That is, the establishment extracting unit 408 determines whether the ‘cinema house name’ of the k-th record matches the cinema house selected by the user of the client 101 (Step S1506).

If these two values match (Yes at Step S1506), the establishment extracting unit 408 determines if the ‘to-and-fro time’ of the k-th record is less than the time obtained by subtracting the ‘required time’ of the i-th record from the available time period calculated in Step S902 shown in FIG. 9 (Step S1507). In other words, the establishment extracting unit 408 determines if the value obtained by adding the to-and-fro time between the cinema house and the establishment and the required time for the establishment is within the available time period until the show time.

If the to-and-fro time between the cinema house and the establishment is less than the time obtained by subtracting the required time from the available time period (Yes at Step S1507), the establishment extracting unit 408 writes the k-th record to the temporary establishment table (Step S1508).

The establishment extracting unit 408 then increments the variable k by 1 (Step S1509), and determines if the variable k after incrementing is less than the total count of the records stored in the establishment table 407 (Step S1510). If the variable k is less than the total count of the records stored in the establishment table 407 (Yes at Step S1510), the establishment extracting unit 408 repeats the process for the k-th record, that is, the next record, in the establishment table 407. That is, the process returns to Step S1504.

If the variable k is more than the total count of the records in the establishment table 407 (No at Step S1510), the establishment extracting unit 408 arranges the records in the temporary establishment table created in Step S1508 in the ascending order of the ‘to-and-fro time’, that is, in such a way that the shortest to-and-fro time is first on the list and the longest to-and-fro time is last on the list (Step S1511). The establishment extracting unit 408 then writes the records arranged in the ascending order to the search result table 409 (Step S1512).

The establishment extracting unit 408 increments the variable i by 1 (Step S1513), and determines if the variable i after incrementing is less than the total count of the records stored in the temporary establishment type table (Step S1514). If the variable i is less than the total count of the records in the temporary establishment type table (Yes at Step 1514), the establishment extracting unit 408 repeats the process for the i-th record, that is, the next record, in the temporary establishment type table. That is, the process returns to Step S1502.

If the variable i is more than the total count of the records stored in the temporary establishment type table (No at Step S1514), the establishment extraction process of Step S904 shown in FIG. 9 ends, and the process proceeds to the search result output process of Step S905.

The web page creating unit 410 refers to the search result table 409 created by the establishment extracting unit 408. Using the data in the search result table 409, the web page creating unit 410 creates a search result page (a Web page containing a list of establishments that can be visited), and transmits the search result table 409 to the client 101. The Web page is transmitted from the transceiver 400 via the Internet 103 and the wireless base station 102 to the transceiver 411 of the client 101, and is displayed on the screen by the display unit 413 (Step S905).

In the search result page shown in FIG. 16, the sequence of the records in a search result list 1600 is identical to the sequence of the records in the search result table 409 shown in FIG. 8. However, the establishments of each type of the field ‘establishment type’ are grouped together, and appear one below another, ‘Restaurant’ appearing first, followed by ‘Book store’, and lastly ‘Coffee house’. The establishments are arranged in the descending order of their required time as can be discerned in the required time table 405 shown in FIG. 6. Within each establishment type, the establishments are arranged in the ascending order of the field ‘to-and-fro time’ of the search result list 1600. That is, in search result list shown in FIG. 16, the book store ‘HHH . . . ’, which has a shorter to-and-fro time, appears above the book store ‘GGG . . . ’.

This order is obtained by extracting the establishment type along with its required time from the required time table 405, and sorting the establishment type in the descending order of the required time (Step S1407 of FIG. 14), then sorting in the ascending order of their to-and-fro time the establishment of the establishment type one by one in their sequence (Step S1511 of FIG. 15), and writing to the search result table 409 in that sequence (Step S1512 of FIG. 15).

Clicking on the Map button 1601 in FIG. 16 displays a detailed map of the establishment to the left of the Map button 1601, and the cinema house specified by the user.

The present embodiment is described entirely for the purpose of utilizing an unexpected free time arising at a cinema house. However, the embodiment may be employed in other situations such as theaters or stadiums or railway stations and air terminals, where free time is likely to arise due to seats not being available.

The information provided in the present embodiment is the name, location, type of the establishments, to-and-fro time, and area map. However, the information provided need not be confined to these and may also include product or service menu of the establishment for the day, greetings of shop manager, news editions, home page URL, etc. Information may also be provided about culture-related establishments such as a beauty salon, library, etc, outdoor places such as a park, botanical garden, etc., or a famous historical site, and the like.

Further, in the present embodiment, the required time for each establishment type is preset. However, 60 minutes at a restaurant may seem too short for one user, and too long for another. Therefore, in order to accommodate the user's personal preferences, the user may be allowed to set a personalized required time for each establishment type.

In the present embodiment, all establishments that can be visited, irrespective of the type, are displayed for the user's benefit. However, the user may be allowed to select the establishment type. That is, if a user would rather spend time at a bookstore than at a coffee house, or if the user does not require information pertaining to restaurants if he/she plans to eat at home, the user may be allowed to select the establishment type he/she would like to have information about.

Further, each user may be allowed to store keywords signifying their interests, in the server 100. To provide information, the server 100 may select the establishment type based on the interest of the user who is querying. That is, the server 100 may present the establishment type on the basis of user preference. Additionally, the user may be allowed to preset the maximum number of establishments listed.

In the present embodiment, the feasibility of visiting an establishment is determined based on the to-and-fro time between the cinema house and the establishment and the average time required at the establishment. The average time required at the establishment depends on the establishment type. However, the user may be allowed to determine the feasibility of visiting a particular establishment by additionally providing information such as business hours, holidays, etc. of the establishments.

The information providing method according to the present embodiment is realized by executing a ready program on a personal computer or a workstation. However, it is also possible to record the program on a computer-readable recording medium such as an HD, FD, CD-ROM, MO, DVD, and the like, and load to the computer therefrom. Alternatively, the program can be loaded from a network, such as the Internet.

Thus, according to the present invention, first the available time period within which the user must reach a certain location (this includes reaching the location from another place, and going elsewhere from the location and returning to the location) is calculated. Next, only those establishments from among the establishments near the location are extracted, for which the sum of the to-and-fro time between the location and the establishment and the average time required at the establishment is within the available time period. Information pertaining to the extracted establishments is transmitted to the user terminal device. Consequently, the user can usefully spend any free time that may arise unexpectedly.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An information providing method comprising:
receiving position information from a terminal device of a user, wherein the position information identifies a location;
receiving time information from the terminal device, wherein the time information identifies a time by which the user must reach the location;
calculating an available time period that is from a current time up to the time identified by the time information;
identifying establishment information that is establishments that can be visited within the available time period, from among establishments near the location; and
transmitting the establishment information to the terminal device.

2. The information providing method according to claim 1, wherein the identifying includes identifying as the establishment information, those establishments for which the sum of a to-and-fro time between the location and the establishment and a required time at the establishment is less than the available time period.

3. The information providing method according to claim 2, further comprising:
sorting, in an ascending order of the to-and-fro time, the pieces of establishment information having identical required time, from among the establishment information,
wherein the transmitting includes transmitting the establishment information sorted.

4. The information providing method according to claim 1, further comprising:
transmitting pieces of the time information to the terminal device,
wherein the receiving time information includes receiving, from the terminal device, any one piece of the time information selected by the user from among the pieces of time information transmitted.

5. The information providing method according to claim 1, wherein
the position information is a name of a cinema house, and
the time information is a start time of a movie at the cinema house.

6. A computer program that includes instructions, which when executed by a computer, cause the computer to execute:
receiving position information from a terminal device of a user, wherein the position information identifies a location;
receiving time information from the terminal device, wherein the time information identifies a time by which the user must reach the location;
calculating an available time period that is from a current time up to the time identified by the time information;
identifying establishment information that is establishments that can be visited within the available time period, from among establishments near the location; and
transmitting the establishment information to the terminal device.

7. The computer program according to claim 6, wherein the identifying includes identifying as the establishment information, those establishments for which the sum of a to-and-fro time between the location and the establishment and a required time at the establishment is less than the available time period.

8. The computer program according to claim 7, further comprising:
sorting, in an ascending order of the to-and-fro time, the pieces of establishment information having identical required time, from among the establishment information,
wherein the transmitting includes transmitting the establishment information sorted.

9. The computer program according to claim 6, wherein
the position information is a name of a cinema house, and
the time information is a start time of a movie at the cinema house.

10. A computer-readable recording medium that records thereon, a computer program including instructions, which when executed by a computer, cause the computer to execute:
receiving position information from a terminal device of a user, wherein the position information identifies a location;
receiving time information from the terminal device, wherein the time information identifies a time by which the user must reach the location;
calculating an available time period that is from a current time up to the time identified by the time information;
identifying establishment information that is establishments that can be visited within the available time period, from among establishments near the location; and
transmitting the establishment information to the terminal device.

11. An information providing device comprising:
a position information receiving unit that receives position information from a terminal device of a user, wherein the position information identifies a location;
a time information receiving unit that receives time information from the terminal device, wherein the time information identifies a time by which the user must reach the location;
an available time calculating unit that calculates an available time period that is from a current time up to the time identified by the time information;
an establishment information identifying unit that identifies establishment information that is establishments that can be visited within the available time period, from among establishments near the location; and
an establishment information transmitting unit that transmits the establishment information to the terminal device.

12. The information providing device according to claim 11, wherein the establishment information identifying unit identifies as the establishment information, those establishments for which the sum of a to-and-fro time between the location and the establishment and a required time at the establishment is less than the available time period.

13. The information providing device according to claim 12, further comprising:
a sorting unit that sorts, in an ascending order of the to-and-fro time, the pieces of establishment information having identical required time, from among the establishment information,
wherein the establishment information transmitting unit transmits the establishment information sorted.

14. The information providing device according to claim 11, wherein
the position information is a name of a cinema house, and
the time information is a start time of a movie at the cinema house.
